(19) United States
(12) Patent Application Publication
(10) Pub. No.: US 2021/0402232 A1
(43) Pub. Date: Dec. 30, 2021

(54) DISCHARGE OF LOW STABILITY FIRE SUPPRESION AGENT IN AIRCRAFT CARGO BAY

(71) Applicant: Kidde Graviner Limited, Shirley (GB)

(72) Inventors: Adam Chattaway, Old Windsor (GB); Eli Baldwin, Knightdale, NC (US); Terry Simpson, Wake Forest, NC (US)

(21) Appl. No.: 16/915,066

(22) Filed: Jun. 29, 2020

(51) Int. Cl. A62C 3/02; A62C 35/64; A62C 37/38; A62D 1/00; A62C 99/00

(52) U.S. Cl. CPC A62C 3/0207; A62C 35/64; B64D 2045/009; A62D 1/0092; A62C 99/0027; A62C 37/38

(57) ABSTRACT

A fire suppression method and system in an aircraft involves a pressurized first-stage agent, and a pressurized second-stage agent. The first-stage agent or the second-stage agent includes trifluoromethyl iodide (CF₃I). A plurality of outlets discharge the first-stage agent during a first duration and the second-stage agent during a second duration. An opening of each of the plurality of outlets is located in a lower quarter of a height of a cargo compartment.

### BACKGROUND

Exemplary embodiments pertain to the art of aircraft fire suppression and, in particular, to the discharge of a low stability fire suppression agent in an aircraft cargo bay.

Smoke detection and fire suppression are important functions in many environments. In an aircraft, for example, the functions are critical. This is because, unlike in other environments where escape is possible, quick suppression of a fire is vital to the integrity of the aircraft. and the safety of the passengers. Smoke detection systems monitor the cargo compartment. Once an overheat or fire condition is detected, suppression may be undertaken in two stages, an initial phase followed by a sustained phase.

### BRIEF DESCRIPTION

In one embodiment, a fire suppression system in an aircraft includes a pressurized first-stage agent and a pressurized second-stage agent. The first-stage agent or the second-stage agent includes trifluoromethyl iodide (CF₃I). A plurality of outlets discharge the first-stage agent during a first duration and the second-stage agent during a second duration. An opening of each of the plurality of outlets is located in a lower quarter of a height of a cargo compartment.

Additionally or alternatively, in this or other embodiments, the first-stage agent or the second-stage agent consists of CF₃I.

Additionally or alternatively, in this or other embodiments, the first-stage agent or the second-stage agent is a cooling agent including nitrogen, argon, or carbon dioxide.

Additionally or alternatively, in this or other embodiments, the first-stage agent or the second-stage agent is a blend of CF₃I and a cooling agent including nitrogen, argon, or carbon dioxide.

Additionally or alternatively, in this or other embodiments, the first-stage agent is a blend of CF₃I and a cooling agent including nitrogen, argon, or carbon dioxide and the second-stage agent is CF₃I.

Additionally or alternatively, in this or other embodiments, the opening of each of the plurality of outlets discharges via corresponding openings in a transitional wall of the cargo compartment. The transitional wall is a transition between a vertical surface and a horizontal surface defining the cargo compartment.

Additionally or alternatively, in this or other embodiments, the opening of each of the plurality of outlets discharges via corresponding openings in a floor of the cargo compartment.

Additionally or alternatively, in this or other embodiments, the opening of each of the plurality of outlets discharges via corresponding openings in a portion of a side wall of the cargo compartment that is below a quarter of a height of the cargo compartment.

In another embodiment, a method of performing fire suppression in an aircraft includes receiving a trigger from a fire detection system and controlling a discharge of a first-stage agent and a discharge of a second-stage agent via a plurality of outlets that each have an opening in a cargo compartment. The first-stage agent or the second-stage agent includes trifluoromethyl iodide (CF₃I) stored under pressure. An opening of each of the plurality of outlets is located in a lower quarter of a height of a cargo compartment.

Additionally or alternatively, in this or other embodiments, the first-stage agent or the second-stage agent consists of CF₃I.

Additionally or alternatively, in this or other embodiments, the first-stage agent or the second-stage agent is a cooling agent including nitrogen, argon, or carbon dioxide.

Additionally or alternatively, in this or other embodiments, the first-stage agent or the second-stage agent is a blend of CF₃I and a cooling agent including nitrogen, argon, or carbon dioxide.

Additionally or alternatively, in this or other embodiments, the first-stage agent is a blend of CF₃I and a cooling agent including nitrogen, argon, or carbon dioxide and the second-stage agent is CF₃I.

Additionally or alternatively, in this or other embodiments, the controlling the discharge is from openings of the plurality of outlets via corresponding openings in a transitional wall of the cargo compartment. The transitional wall is a transition between a vertical surface and a horizontal surface defining the cargo compartment.

Additionally or alternatively, in this or other embodiments, the controlling the discharge is from openings of the plurality of outlets via corresponding openings in a floor of the cargo compartment.

Additionally or alternatively, in this or other embodiments, the controlling the discharge is from openings of the plurality of outlets via corresponding openings in a portion of a side wall of the cargo compartment that is below a quarter of a height of the cargo compartment.

In yet another embodiment, a method of configuring a fire suppression system in an aircraft includes disposing a distribution line to supply a plurality of outlets with a first-stage agent and a second-stage agent for dispersal. The method also includes configuring each of the plurality of outlets with an opening into a cargo compartment of the aircraft. The first-stage agent or the second-stage agent includes trifluoromethyl iodide (CF₃I) stored under pressure. The opening of each of the plurality of outlets is located in a lower quarter of a height of the cargo compartment.

Additionally or alternatively, in this or other embodiments, the configuring the plurality of outlets includes arranging the plurality of outlets such that discharge from corresponding openings of the plurality of outlets is via corresponding openings in a transitional wall of the cargo compartment. The transitional wall being a transition between a vertical surface and a horizontal surface defining the cargo compartment.

Additionally or alternatively, in this or other embodiments, the configuring the plurality of outlets includes arranging the plurality of outlets such that discharge from corresponding openings of the plurality of outlets is via corresponding openings in a floor of the cargo compartment.

Additionally or alternatively, in this or other embodiments, the configuring the plurality of outlets includes arranging the plurality of outlets such that discharge from corresponding openings of the plurality of outlets is via corresponding openings in a portion of a side wall of the cargo compartment that is below a quarter of a height of the cargo compartment.

### BRIEF DESCRIPTION OF THE DRAWINGS

The following descriptions should not be considered limiting in any way. With reference to the accompanying drawings, like elements are numbered alike:

FIG. 1 illustrates aspects of an aircraft that includes a low stability fire suppression agent for discharge in the cargo compartment according to one or more embodiments;

FIG. 2 is a cross-sectional view through A-A of the cargo compartment that includes a low stability fire suppression agent for discharge according to one or more embodiments;

FIGS. 3A and 3B show two perspective views of a fire suppression system according to one or more embodiments; and

FIG. 4 is a process flow of a method of performing fire suppression in a cargo compartment of an aircraft according to one or more embodiments.

### DETAILED DESCRIPTION

A detailed description of one or more embodiments of the disclosed apparatus and method are presented herein by way of exemplification and not limitation with reference to the Figures.

As previously noted, fire suppression is an important function in aircraft systems. In prior aircraft fire suppression systems, Halon 1301 is distributed into the cargo bay, for example, via a distribution system. Halon is an ozone-depleting substance whose production has ceased under the Montreal Protocol. Thus, environmentally friendly fire suppression agents are being developed as replacements for Halon.

Embodiments of the systems and methods detailed herein relate to the discharge of a low stability fire suppression agent in an aircraft cargo bay. Recently, trifluoroiodomethane or trifluoromethyl iodide (CF₃I) has been considered as an efficient and environmentally friendly fire suppression agent. However, the standard test protocol revealed an issue with the use of CF₃I. The test protocol involves the discharge of an extinguishing agent two minutes after a ceiling-mounted thermocouple has registered 200 degrees Fahrenheit (° F.). This scenario results in a large volume of hot gas near the ceiling with temperatures ranging from 600 to in excess of 1500° F. But, CF₃I, which is a low stability fire suppression agent as compared with Halon, for example, starts to break down at temperatures over 600° F.

Computational fluid dynamics modeling and analysis of the temperature distribution pattern within the cargo compartment was undertaken. As a result, embodiments detailed herein relate to using CF₃I as a fire suppression agent that is discharged lower down in the cargo compartment as compared with typical ceiling-mounted distribution systems. Even at temperatures as high as 600° F., the calculated half-life of CF₃I is in excess of 10 hours. Further, CF₃I is injected with sufficient momentum to negate any effects of gravity. The systems and methods according to exemplary embodiments include using CF₃I in one or both phases of fire suppression and arranging the distribution system in the cheek of the cargo compartment to specifically address the stability of CF₃I.

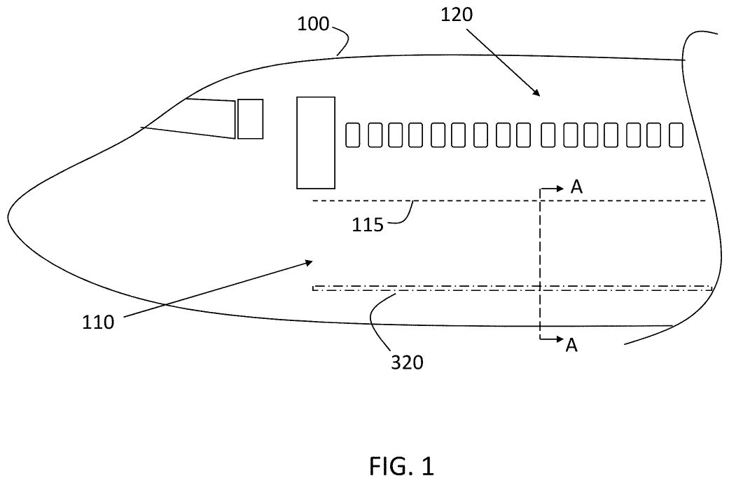

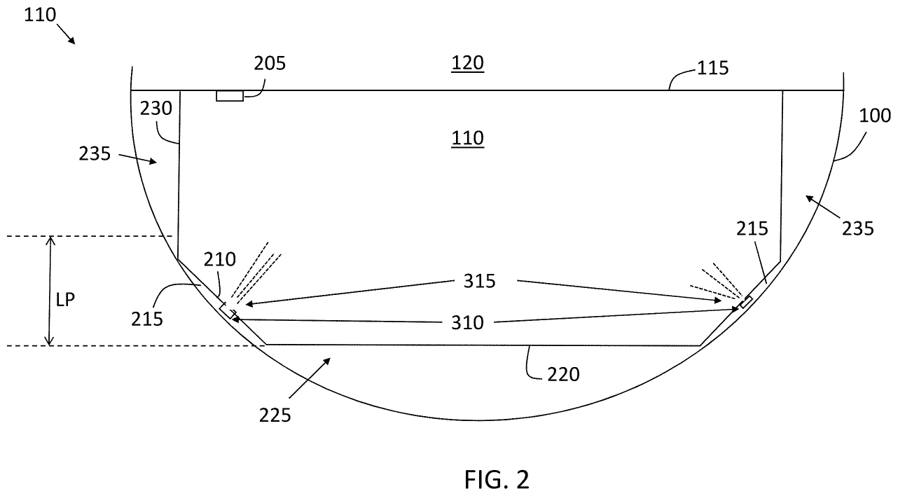

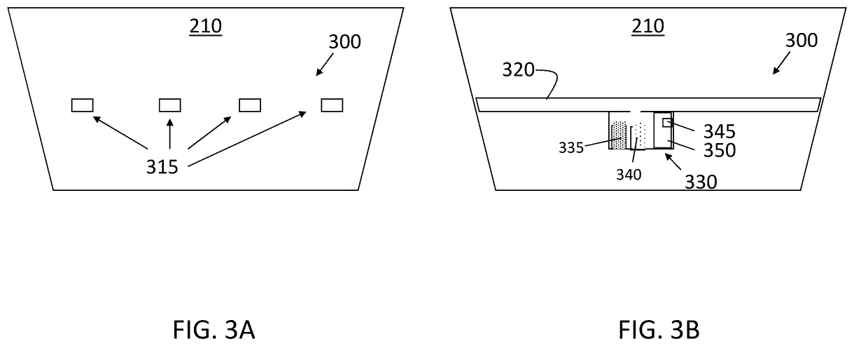

FIG. 1 illustrates aspects of an aircraft 100 that includes a low stability fire suppression agent for discharge in the cargo compartment 110 according to one or more embodiments. The exemplary aircraft 100 includes a cargo compartment 110 and a passenger compartment 120, separated by a divider 115 that is generally indicated by the dashed line in FIG. 1. While the exemplary passenger compartment 120 is shown as one level, the passenger compartment 120 may include multiple levels according to alternate embodiments. A distribution line 320 of the fire suppression system 300 (FIG. 2) in the cargo compartment 110 is indicated. The fire suppression system 300 is further detailed with reference to FIG. 3. Fire suppression components are also generally present in other parts of the aircraft 100 (e.g., passenger compartment 120, engines, cockpit) but are not indicated. A cross-section indicated as A-A is shown in FIG. 2.

FIG. 2 is a cross-sectional view through A-A of the cargo compartment 110 that includes a low stability fire suppression agent for discharge according to one or more embodiments. The passenger compartment 120 is indicated above the cargo compartment 110. The two compartments 110, 120 are separated by the divider 115 that defines a ceiling of the cargo compartment 110 and a floor of the passenger compartment 120. An exemplary fire detection system 205 is shown at the ceiling level. According to a prior approach, discharge of fire suppression materials in the cargo compartment 110 is also performed at the ceiling level, just below the divider 115. Even prior systems that include nozzles at different heights do not select the nozzle height based on the thermal analysis of the suppression materials. According to one or more embodiments, the placement of the outlets 310 is based on the thermodynamic modelling and analysis specific to CF₃I distribution during a fire.

In addition to the divider 115 that defines the ceiling of the cargo compartment 110, side walls 230, transitional walls 210, and a floor 220 define the remainder of the perimeter of the space. Behind each transitional wall 210 is in an area referred to as a cheek area 215. Each transitional wall 210 provides a transition between one of the side walls 230 and the floor 220, as shown. As also shown in FIG. 2, there are spaces 235 between each of the side walls 230 and the outer perimeter of the aircraft 100 and a space 225 between the floor 220 and the outer perimeter of the aircraft 100. Outlets 310 that are part of the fire suppression system 300 (FIG. 3) are shown to extend from the cheek area 215 behind each of the transitional walls 210 through openings in the transitional walls 210 such that an opening 315 of each outlet 310 is flush with the respective transitional wall 210.

According to alternate embodiments, the outlets 310 may be within or behind corresponding holes in the transitional wall 210. In any case, the outlets 310 are arranged such that discharge of fire suppressive agents into the cargo compartment 110 is via corresponding openings in the transitional wall 210. According to exemplary embodiments, components of the fire suppression system 300 do not extend into the cargo compartment 110. Intrusion of components of the fire suppression system 300 into the cargo compartment 110 may result in damage to the components from cargo or reduction in the area available for cargo. The components of the fire suppression system 300 are detailed with reference to FIGS. 3A and 3B.

According to further alternate embodiments, the outlets 310 may be located in the space 225 under the floor 220 or in lower portions of the spaces 235 behind the side walls 230. That is, the outlets 310 may come through openings in the floor 220 or lower portions of the side walls 230 and have openings 315 that are flush with the floor 220 or lower portions of the side walls 230 or that are aligned with holes in the floor 220 or lower portions of the side walls 230. In either case, the openings 315 are arranged to discharge via holes in the floor 220 or lower portions of the side walls 230. Lower portion refers to the fact that the modeling and analysis indicates that the openings 315 must discharge in the lower portion, indicated as LP in FIG. 2, of the cargo compartment 110. This lower portion LP may be about the bottom 25 percent of the cargo compartment 110. Thus, the outlets 310 may be under the floor 220, in the cheek area 215 behind the transitional walls 210, or in the spaces 235 behind some portions of the side walls 230.

FIGS. 3A and 3B show two perspective views of a fire suppression system 300 according to one or more embodiments. Continuing reference is made to FIGS. 1 and 2. FIG. 3A shows a view of the transitional wall 210 from the cargo compartment 110. As indicated, only the openings 315 of the outlets 310 are visible from within the cargo compartment. As discussed with reference to FIG. 3B, different materials flow from the openings 315 at different phases of fire suppression. The openings 315 are shown flush with the transitional wall 210 for explanatory purposes. However, as previously noted, the openings may be flush with the floor 220 or lower portions of the side walls 230 or may be aligned with holes in the transitional walls 210, floor 220, or side walls 230 in alternate embodiments.

FIG. 3B shows a view of the transitional wall 210 from the space 215 between the transitional wall 210 and the outer perimeter of the aircraft 100. The distribution line 320 and other components 330 are shown. The other components 330 include those that store and initiate discharge of first-stage and second-stage agents. These other components 330 are known and only generally described here. For example, storage container 335 may include the first-stage agent while storage container 340 includes the second-stage agent. A receiver 345 may receive a trigger from a fire detection system 205 to initiate discharge of the first-stage agent and second-stage agent. The receiver 345 may be part of a control unit 350 of the fire suppression system 300.

The first stage and second stage may be referred to, respectively, as high rate discharge (HRD) and low rate discharge (LRD) phases. The substance discharged during the first HRD phase (i.e., first-stage agent 235) and during the second LRD phase (i.e., the second-stage agent 240) may be CF₃I, a cooling agent (e.g., nitrogen, argon, or carbon dioxide), or a blend of CF₃I and the cooling agent. The first-stage agent and the second-stage agent may be different. Both are stored in a pressurized state in their respective storage containers 335, 340. A control unit 350 that is part of the other components 330 may control squib actuation of a blowdown valve of the storage containers such that the first-stage agent 235 and then the second-stage agent 240 are discharged until the are depleted. The delay between the first HRD phase and the second LRD phase may be on the order of seconds to minutes. In alternate embodiments, the first-stage agent 235 and the second-stage agent 240 may be discharged simultaneously.

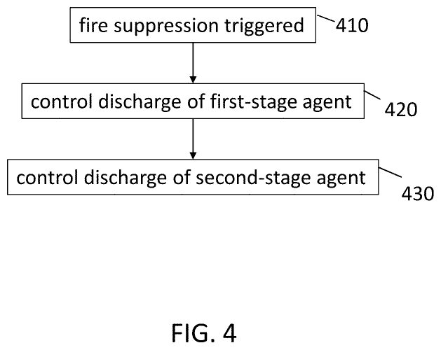

FIG. 4 is a process flow 400 of a method of performing fire suppression in a cargo compartment 110 of an aircraft 100 according to one or more embodiments. At block 410, the process flow begins when the fire suppression function is triggered. The trigger may be based on one or more fire detection systems 205. As previously noted, fire suppression may be performed in two different stages and may involve two different suppressive agents, a first-stage agent 235 and a second-stage agent 240. At block 420, controlling a discharge of a first-stage agent 235 may be performed until the first-stage agent is depleted. As previously noted, the first-stage agent 235 is pressurized and may be CF₃I, a cooling agent (e.g., nitrogen, argon, or carbon dioxide), or a blend of CF₃I and the cooling agent The discharge is via the openings 315 of the outlets 310 that come through the transitional walls 210, the floor 220, or lower portions of the side walls 230 such that the discharge is into the cargo compartment 110 at a height that is lower than about a quarter of the height of the cargo compartment 110.

At block 430, controlling a discharge of a second-stage agent 240 may be performed until the second-stage agent 240 is depleted. As previously noted, there may be a time delay between the processes at blocks 420 and 430 or the processes may be simultaneous. As previously noted, the second-stage agent 240 is pressurized and may be CF₃I, a cooling agent (e.g., nitrogen, argon, or carbon dioxide), or a blend of CF₃I and the cooling agent. The discharge is via the same openings 315 in the transitional walls 210 that are used to discharge the first-stage agent 235.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fire suppression system in an aircraft comprising:
a pressurized first-stage agent;
a pressurized second-stage agent, wherein the first-stage agent or the second-stage agent includes trifluoromethyl iodide (CF₃I); and
a plurality of outlets configured to discharge the first-stage agent during a first duration and the second-stage agent during a second duration, wherein an opening of each of the plurality of outlets is located in a lower quarter of a height of a cargo compartment.

2. The fire suppression system according to claim 1, wherein the first-stage agent or the second-stage agent consists of CF₃I.

3. The fire suppression system according to claim 1, wherein the first-stage agent or the second-stage agent is a cooling agent including nitrogen, argon, or carbon dioxide.

4. The fire suppression system according to claim 1, wherein the first-stage agent or the second-stage agent is a blend of CF₃I and a cooling agent including nitrogen, argon, or carbon dioxide.

5. The fire suppression system according to claim 1, wherein the first-stage agent is a blend of CF₃I and a cooling agent including nitrogen, argon, or carbon dioxide and the second-stage agent is CF₃I.

6. The fire suppression system according to claim 1, wherein the opening of each of the plurality of outlets is configured to discharge via corresponding openings in a transitional wall of the cargo compartment, the transitional wall being a transition between a vertical surface and a horizontal surface defining the cargo compartment.

7. The fire suppression system according to claim 1, wherein the opening of each of the plurality of outlets is configured to discharge via corresponding openings in a floor of the cargo compartment.

8. The first suppression system according to claim 1, wherein the opening of each of the plurality of outlets is configured to discharge via corresponding openings in a portion of a side wall of the cargo compartment that is below a quarter of a height of the cargo compartment.

9. A method of performing fire suppression in an aircraft, the method comprising:
receiving a trigger from a fire detection system; and
controlling a discharge of a first-stage agent and a discharge of a second-stage agent via a plurality of outlets that each have an opening in a cargo compartment, wherein the first-stage agent or the second-stage agent includes trifluoromethyl iodide (CF₃I) stored under pressure, and an opening of each of the plurality of outlets is located in a lower quarter of a height of a cargo compartment.

10. The method according to claim 9, wherein the first-stage agent or the second-stage agent consists of CF₃I.

11. The method according to claim 9, wherein the first-stage agent or the second-stage agent is a cooling agent including nitrogen, argon, or carbon dioxide.

12. The method according to claim 9, wherein the first-stage agent or the second-stage agent is a blend of CF₃I and a cooling agent including nitrogen, argon, or carbon dioxide.

13. The method according to claim 9, wherein the first-stage agent is a blend of CF₃I and a cooling agent including nitrogen, argon, or carbon dioxide and the second-stage agent is CF₃I.

14. The method according to claim 9, wherein the controlling the discharge is from openings of the plurality of outlets via corresponding openings in a transitional wall of the cargo compartment, the transitional wall being a transition between a vertical surface and a horizontal surface defining the cargo compartment.

15. The method according to claim 9, wherein the controlling the discharge is from openings of the plurality of outlets via corresponding openings in a floor of the cargo compartment.

16. The method according to claim 9, wherein the controlling the discharge is from openings of the plurality of outlets via corresponding openings in a portion of a side wall of the cargo compartment that is below a quarter of a height of the cargo compartment.

17. A method of configuring a fire suppression system in an aircraft, the method comprising:
disposing a distribution line to supply a plurality of outlets with a first-stage agent and a second-stage agent for dispersal;
configuring each of the plurality of outlets with an opening into a cargo compartment of the aircraft, wherein the first-stage agent or the second-stage agent includes trifluoromethyl iodide (CF₃I) stored under pressure, and the opening of each of the plurality of outlets is located in a lower quarter of a height of the cargo compartment.

18. The method according to claim 17, wherein the configuring the plurality of outlets includes arranging the plurality of outlets such that discharge from corresponding openings of the plurality of outlets is via corresponding openings in a transitional wall of the cargo compartment, the transitional wall being a transition between a vertical surface and a horizontal surface defining the cargo compartment.

19. The method according to claim 17, wherein the configuring the plurality of outlets includes arranging the plurality of outlets such that discharge from corresponding openings of the plurality of outlets is via corresponding openings in a floor of the cargo compartment.

20. The method according to claim 17, wherein the configuring the plurality of outlets includes arranging the plurality of outlets such that discharge from corresponding openings of the plurality of outlets is via corresponding openings in a portion of a side wall of the cargo compartment that is below a quarter of a height of the cargo compartment.
